(19) United States
(12) Patent Application Publication
(10) Pub. No.: US 2020/0166391 A1
(43) Pub. Date: May 28, 2020

(54) FORCE MEASUREMENT DEVICE FOR FLUID CONTROL VALVE

(71) Applicant: BION INC., NEW TAIPEI CITY (TW)

(72) Inventor: YU-YU CHEN, TAIPEI CITY (TW)

(21) Appl. No.: 16/687,871

(22) Filed: Nov. 19, 2019

(30) Foreign Application Priority Data
Nov. 23, 2018 (TW) 107141962

(51) Int. Cl. G01F 1/34; G01L 7/08; G01F 1/20

(52) U.S. Cl. CPC G01F 1/34; G05D 16/185; G01F 1/206; G01L 7/082

(57) ABSTRACT

A force measurement device for a fluid control valve is disclosed, in which a force measurement device is coupled between a driving axle of a driver device and a valve rod of a fluid control valve. The force measurement device includes a sensor seat, which is coupled between the driving axle of the driver device and the valve rod of the fluid control valve. A plurality of stress detection units are arranged and positioned on the sensor seat in an annular configuration and are spaced from each other by an angle. The plurality of stress detection units are operable to measure a magnitude of a force applied to the valve rod according to deformation of the sensor seat and generates a plurality of stress variation signals that are transmitted to a control device.

### BACKGROUND OF THE INVENTION

### 1. Field of the Invention

The present invention relates to a force control device of a fluid control valve, and in particular to a force measurement device for a fluid control valve.

### 2. The Related Arts

Fluid control valves have been widely used in various kinds of industries applications, public facility, and residences. A fluid control valve has a terminal port that is connectable with a pipeline and the fluid control valve is operable to pass or cut off fluid flowing along the pipeline.

Various types of fluid control valve are available, such as a ball valve and a diaphragm valve. Taking a ball valve as an example, a valve body is provided, in an interior thereof, with a ball, and the ball is connected to a valve rod, so that the valve rod is operable to control a movement of the ball for controlling fluid to pass or not.

The control the operation of a fluid control valve, control techniques have been developed to provide an apparatus that includes a driver device combined with a fluid control valve, such that the operation of the fluid control valve is controllable by means of the driver device together with proper electric control signals. However, in practical applications, the fluid control valve is generally regarded as a switching element that enables passage or blockade of fluid. When components of a fluid control valve, such as the valve rod and the ball, become abnormal due to extended usage, or when the interior of the valve body is jammed by a foreign object, a stress or a torque that is applied to operate the valve rod may be in an unusual condition and the driver device is no longer properly operable for opening and closing the fluid control valve. This may not suit the need for industrial operations particularly in case of remote control.

### SUMMARY OF THE INVENTION

Thus, the primary objective of the present invention is to provide a force measurement device of a fluid control valve, which measures and detects a stress condition of a valve rod of the fluid control valve that is in operation.

The technical solation adopted in the present invention is a force measurement device of a fluid control valve, in which a force measurement device is coupled between a driving axle of a driver device and a valve rod of a fluid control valve. The force measurement device comprises a sensor seat, which is coupled between the driving axle of the driver device and the valve rod of the fluid control valve. A plurality of stress detection units are arranged and positioned on the sensor seat in an annular configuration and are spaced from each other by an angle. The plurality of stress detection units are operable to measure a magnitude of a force applied to the valve rod according to deformation of the sensor seat and generates a plurality of stress variation signals that are transmitted to a control device.

The efficacy is that when the driver device applies a force to the valve rod of the fluid control valve, the force is detected by the plurality of stress detection units arranged on the sensor seat according to the present invention to detect and measure a magnitude of the force applied to the valve rod by detecting variations of stress caused by the force according to deformation of the sensor seat. Thus, the technique of this invention can be used in various applications where detection and measurement are necessary for stress of a valve rod in operation. The technique of the present invention particularly suits applications where remote measurement and remote control are required.

Specific techniques that the present invention adopts will be further described with reference to the following embodiments and the attached drawings.

### BRIEF DESCRIPTION OF THE DRAWINGS

FIG. 1 is a perspective view showing a force measurement device of a fluid control valve according to a first embodiment of the present invention;

FIG. 2 is an exploded view showing the force measurement device of the fluid control valve according to the first embodiment of the present invention, with some components detached therefrom;

FIG. 3 is a perspective view showing a force measurement device of a fluid control valve according to a second embodiment of the present invention;

FIG. 4 is an exploded view showing the force measurement device of the fluid control valve according to the second embodiment of the present invention, with some components detached therefrom;

FIG. 5 is an exploded view showing, in a detached form, a component of the force measurement device of the fluid control valve according to the second embodiment of the present invention;

FIG. 6 is a bottom view showing a sensor seat of FIG. 5 as being observed from an end thereof;

FIG. 6A illustrates, as an alternative, stress detection units of FIG. 6 arranged in an annular configuration on an outer circumferential surface of a sensor seat as being spaced from each other by an angle;

FIG. 6B illustrates, as an alternative, stress detection units of FIG. 6 arranged in an annular configuration and respectively located on rear walls of interior spaces of protrusions of a sensor seat as being spaced from each other by an angle;

FIG. 6C illustrates, as an alternative, multiple stress detection units arranged in an annular configuration on an outer surface of a hexagonal sensor seat as being spaced from each other by an angle;

FIG. 6D illustrates, as an alternative, multiple stress detection units arranged in an annular configuration on a side surface of a hexagonal sensor seat as being spaced from each other by an angle;

FIG. 6E illustrates, as an alternative, multiple stress detection units arranged in an annular configuration on an outer surface of an octagonal sensor seat as being spaced from each other by an angle;

FIG. 6F illustrates, as an alternative, multiple stress detection units arranged in an annular configuration on a side surface of an octagonal sensor seat as being spaced from each other by an angle;

FIG. 7 illustrates a circuit function block diagram of the first embodiment of the present invention;

FIG. 8 illustrates a circuit function block diagram of the second embodiment of the present invention;

FIG. 9A is a schematic view showing a sensor seat arranged between a fluid control valve and a driver device according to the present invention;

FIG. 9B is a schematic view showing, as an alternative, a sensor seat arranged in a driver device according to the present invention; and

FIG. 9C is a schematic view showing, as an alternative, a sensor seat arranged in a fluid control valve according to the present invention.

### DETAILED DESCRIPTION OF THE PREFERRED EMBODIMENTS

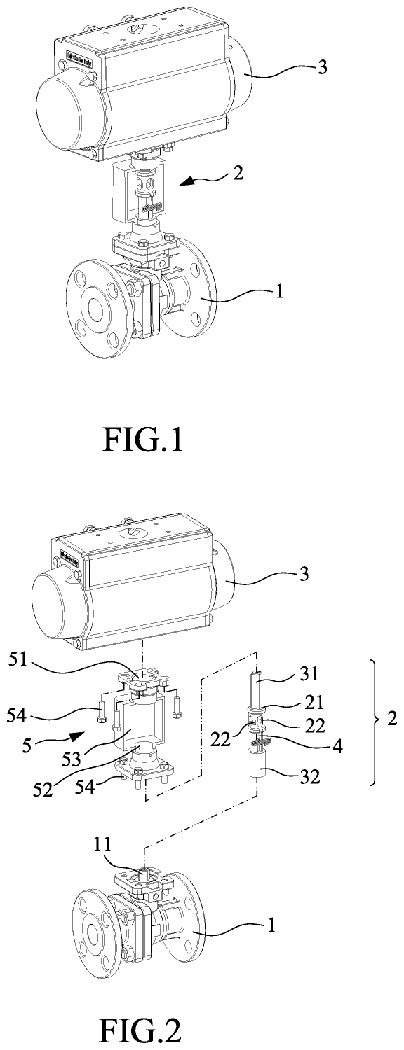

Referring simultaneously to FIGS. 1-2, FIG. 1 is a perspective view showing a force measurement device of a fluid control valve according to a first embodiment of the present invention; and FIG. 2 is an exploded view showing the force measurement device of the fluid control valve according to the first embodiment of the present invention, with some components detached therefrom. As shown in the drawings, a fluid control valve 1 comprises terminal ports arranged at two ends of a valve body. The terminal ports are connectable to a pipeline through which fluid flows. The fluid control valve 1 can be for example a ball valve that includes a ball arranged in an interior of the valve body and a valve rod 11 connected to the ball, so that operation of the valve rod 11 enables control of passage of the fluid through the fluid control valve 1. The fluid control valve 1 can alternatively be a diaphragm valve or control valves of other types.

The fluid control valve 1 is connected, at a portion of a top face thereof that corresponds to a location where the valve rod 11 protrudes outward, to a force measurement device 2 according to the present invention, and the force measurement device 2 is connected, at a top end thereof, to a driver device 3. The force measurement device 2 comprises a sensor seat 21 that has an end connected to a driving axle 31 of the driver device 3 and an opposite end coupled, through an extension rod 32, to the valve rod 11 of the fluid control valve 1.

A plurality of stress detection units 22 are arranged on the sensor seat 21 at predetermined or selected positions. For example, the sensor seat 21 as shown in the drawings is formed as an annular structure, and the plurality of stress detection units are arranged, in an annular configuration, and positioned on (such as being mounted or attached to) one of an outer circumferential surface and an inner circumferential surface of the annular structure and are spaced from each other by an angle

The stress detection units can each be one of a load cell, a semiconductor stress sensor, a capacitive stress sensor, and an inductive stress sensor. The plurality of stress detection units 22 detect a force applied to the valve rod 11 according to deformation of the sensor seat 21 and generates a plurality of stress variation signals that are transmitted to a control device 4. The transmission of the electrical signals can be performed with known devices and parts, such as an electrical connector, a conductor wire, and a conducting ring, to realize transmission and receiving between the control device 4 and an external device.

The force measurement device 2 comprises a coupling seat 5. The coupling seat 5 comprises a first opening 51 adjacent to and corresponding to the driver device 3 to receive extension of the driving axle 31 of the driver device 3 therethrough. The coupling seat 5 further comprises a second opening 52 adjacent to and corresponding to the fluid control valve 1 to receive extension of a valve rod 11 of the fluid control valve 1 therethrough. The coupling seat 5 is also formed with a sensor seat accommodation space 53 between the first opening 51 and the second opening 52 to receive and hold the sensor seat 21 therein. The first opening 51 and the second opening 52 of the coupling seat 5 are fixed, as being arranged between the fluid control valve 1 and the driver device 3, by a plurality of fastener elements 54.

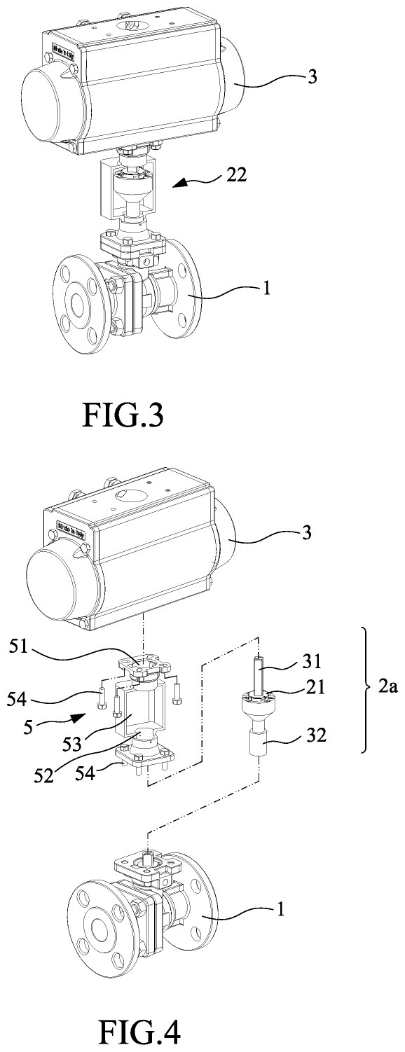

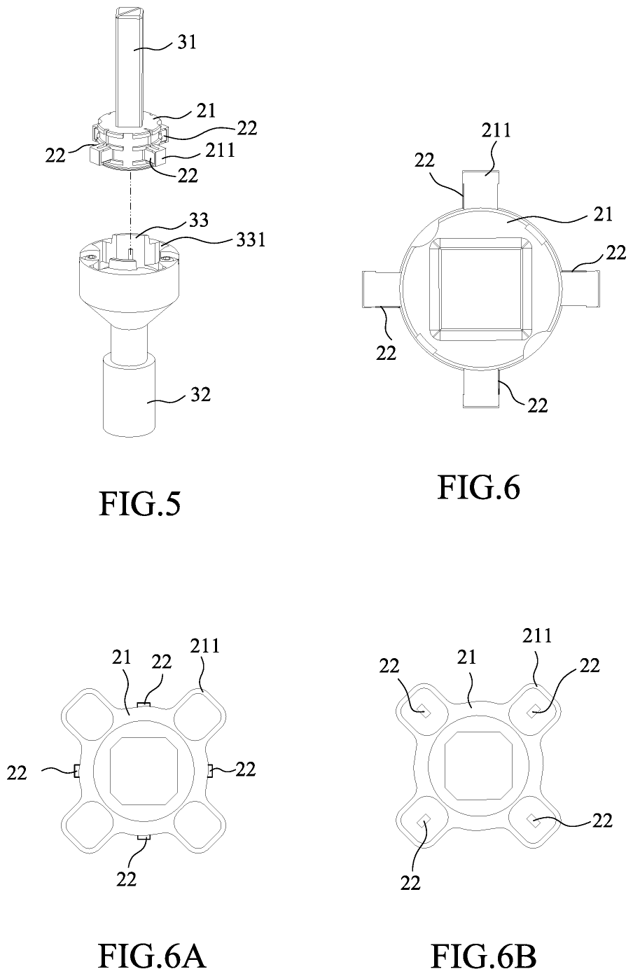

FIG. 3 is a perspective view showing a force measurement device of a fluid control valve according to a second embodiment of the present invention; FIG. 4 is an exploded view showing the force measurement device of the fluid control valve according to the second embodiment of the present invention, with some components detached therefrom; and FIG. 5 is an exploded view showing, in a detached form, a component of the force measurement device of the fluid control valve according to the second embodiment of the present invention.

In the instant embodiment, constituting components/parts are generally the same as those of the first embodiment, and thus identical elements are designated with the same reference numeral for consistency.

As shown in the drawings, the sensor seat 21 has an end connected to the driving axle 31 of the driver device 3 and an opposite end received in an axle hole 33 formed in a top of the extension rod 32.

The sensor seat 21 are formed, through outward protruding, with multiple protrusions 211 that are raised and arranged on the outer circumferential surface in an annular configuration and are spaced from each other by an angle, and correspondingly, recesses 331 are formed in the axle hole 33 of the extension rod 32, so as to allow the sensor seat 21 to be securely mounted in the axle hole 33 of the extension rod 32. In another preferred embodiment, the sensor seat 21 may be alternatively provided as having for example a polygonal outside surface structure, and this similarly allows the sensor seat 21 to be securely fixed in the axle hole 33 of the extension rod 32.

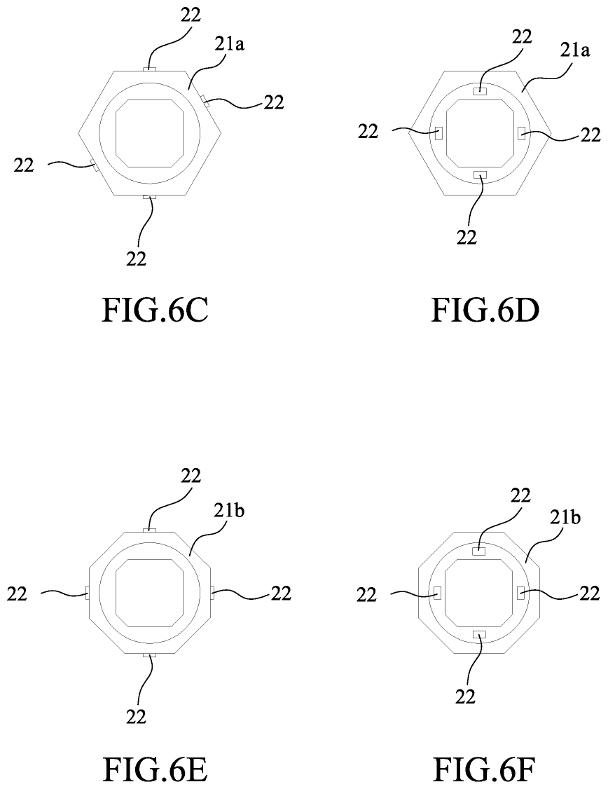

FIG. 6 is a bottom view of the sensor seat 21 of FIG. 5 as being observed from an end thereof. The plurality of stress detection units 22 are respectively positioned in recessed portions formed in side surfaces of the sensor seat 21. Through each of the stress detection unit 21, detection and measurement of a force applied can be realized.

FIGS. 6A-6F illustrate various types of structure that the sensor seat 21 of the present invention may be made. For example, FIG. 6A illustrates the stress detection units 22 are arranged in an annular configuration on the outer circumferential surface of the sensor seat 21 and are spaced from each other by an angle.

Referring to FIG. 6B, an alternative arrangement is illustrated, in which the stress detection units 22 are respectively arranged on rear walls of interior spaces of the protrusions 211 of the sensor seat 21.

The sensor seat 21 can alternatively be arranged to form a polygonal structure. For example, referring to FIG. 6E, the sensor seat can be arranged as a structure of a hexagonal sensor seat 21a and the stress detection units 22 are arranged on an outer surface of the hexagonal sensor seat 21a as being spaced from each other by an angle.

Referring to FIGS. 6C and 6D, as alternatives, the stress detection units 22 are arranged in an annular configuration on outside surfaces (shown in FIG. 6C) or a side surface (shown in FIG. 6D) of the hexagonal sensor seat 21a and spaced from each other by an angle.

Referring to FIG. 6E, as an alternative, the sensor seat can be arranged as a structure of an octagonal sensor seat 21b, and the stress detection units 22 are arranged on an outer surface of the octagonal sensor seat 21b and are spaced from each other by an angle.

Referring to FIG. 6F, as an alternative, the stress detection units 22 are arranged in an annular configuration on a side surface of the octagonal sensor seat 21b and spaced from each other by an angle.

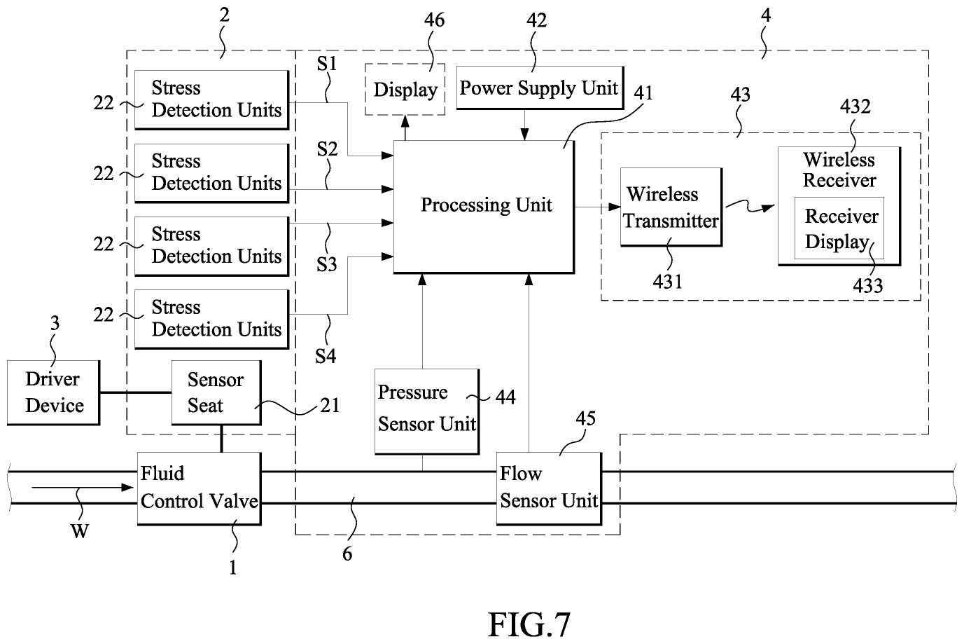

FIG. 7 illustrates a circuit function block diagram of the first embodiment of the present invention. The control device 4 comprises a processor unit 41, an electrical power supply unit 42, and a transmission module 262. The processor unit 41 is electrically connected to each of the stress detection units 22. The electrical power supply unit 42 (such as a battery or electric cell) supplies electrical power to the processor unit 41 and each of the stress detection units 22. The transmission module 43 can be a wired transmission module, or may alternatively be a wireless transmission module.

In a preferred embodiment, the transmission module 43 comprises a wireless transmitter 431 that is electrically connected to the processor unit 41 to transmit, in a wireless manner (such as RF and Bluetooth), a signal to a wireless receiver 432. The wireless receiver 432 is preferably provided with a receiver display 433.

When the driver device 3 applies a force to the valve rod 11 of the fluid control valve 1, the force is detected by the plurality of stress detection units 22 of the sensor seat 21 such that a variation of stress caused by the force so applied can be detected according to a deformation amount of the sensor seat 21, and accordingly, a magnitude of the force applied to the valve rod 11 can be measured and a plurality of stress variation signals S 1, S2, S3, S4 are generated and transmitted to the processor unit 41.

Upon receiving the stress variation signals 51, S2, S3, S4 supplied from each of the stress detection units 22, the processor unit 41 operates for signal processing and calculation (such as noise filtering, signal conversion, and value computation) to acquire data of the force applied to the valve rod 11 of the fluid control valve 1, and a result of the operation is transmitted to the wireless receiver 432 to be displayed on the receiver display 433 of the wireless receiver 432. The wireless receiver 432 can be a receiver on or of a smart phone, a personal wearable device, a gateway, cloud or a wireless network.

The control device 4 may also comprise a pressure sensor unit 44 and/or a flow sensor unit 45 that are connected to the processing unit 41 to respectively sense a pressure of the fluid 6 inside the pipeline 6 and a flow passing through the fluid control valve 1.

Since the stress detection units 22 are arranged and positioned on the sensor seat 21 as being spaced from each by a constant spacing angle (such as 90 degrees or 45 degrees), the force of the operation of the valve rod 11 can be accurately detected and measured according to variations of angle.

The data of the force so detected and measured, in addition to transmission to the receiver display 433, may be displayed on a display 46 connected to the processing unit 41.

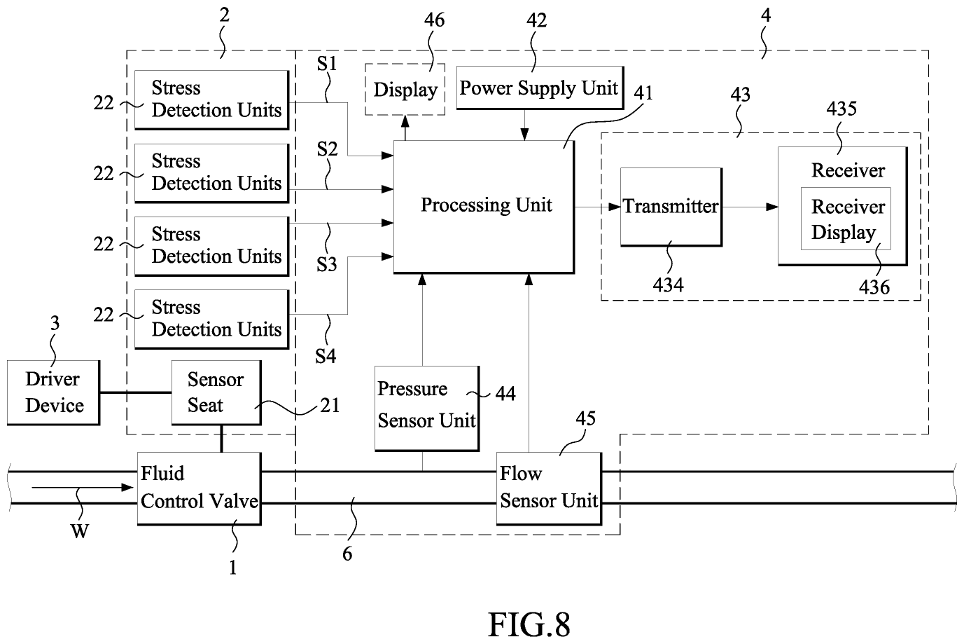

FIG. 8 illustrates a circuit function block diagram of the second embodiment of the present invention. In the instant embodiment, the circuit function block diagram is generally similar to the circuit of the example provided in FIG. 7, with a difference being that after the processing unit 41 receives the stress variation signals 51, S2, S3, S4 transmitted from each of the stress detection units 22, the data of force that is obtained through signal processing and computation is transmitted, in a wired manner, through a wired transmitter 434 to a wired receiver 435 and displayed on a receiver display 436 of the wired received 435.

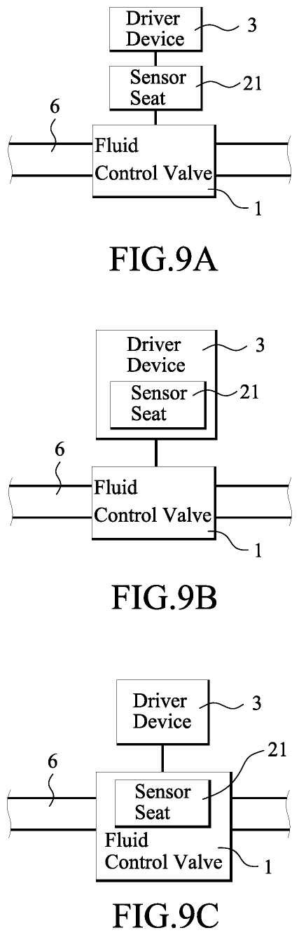

In the previous examples, the sensor seat 21 is arranged between the fluid control valve 1 and the driver device 3. FIG. 9A provides a schematic view showing the arrangement in which the sensor seat 21 is arranged between the fluid control valve 1 and the driver device 3.

In actual fabrication, modifications can be made according to various requirement for products. For example, as shown in FIG. 9B, as an alternative, the sensor seat 21 can be arranged in the driver device 3. In other words, the sensor seat 21 is built in the driver device 3. Further, as shown in FIG. 9C, as a different alternative, the sensor seat 21 is arranged in the fluid control valve 1, meaning the sensor seat 21 is built in the fluid control valve 1.

The above embodiments are provided to illustrate and explain the present invention, and they are not intended to limit the scope of the present invention. Equivalent modifications or substitutes that do not depart from the spirit of the present invention are considered falling in the scope of the appended claims.

What is claimed is:

1. A force measurement device for a fluid control valve having a valve rod connected to a driver device, the driver device comprising a driving axle that drives the valve rod of the fluid control valve, the force measurement device being coupled between the driving axle of the driver device and the valve rod of the fluid control valve, comprising:
a sensor seat coupled between the driving axle of the driver device and the valve rod of the fluid control valve;
a plurality of stress detection units arranged and positioned on the sensor seat in an annular configuration and are spaced from each other by an angle, the plurality of stress detection units being operable to measure a magnitude of a force applied to the valve rod according to deformation of the sensor seat and generating a plurality of stress variation signals that are transmitted to a control device; and
a coupling seat fastened between the fluid control valve and the driver device by a plurality of fastener elements, the coupling seat comprising:
a first opening that is adjacent to and corresponding to the driver device to receive extension of the driving axle of the driver device therethrough,
a second opening that is adjacent to and corresponding to the fluid control valve to receive extension of the valve rod of the fluid control valve therethrough, and
a sensor seat accommodation space that receives and holds the sensor seat therein.

2. The force measurement device for the fluid control valve according to claim 1, wherein the stress detection units are each one of a load cell, a semiconductor stress sensor, a capacitive stress sensor, and an inductive stress sensor.

3. The force measurement device for the fluid control valve according to claim 1, wherein the sensor seat has an outer circumferential surface that is formed with a plurality of protrusions raised therefrom and spaced from each other by an angle, and the plurality of stress detection units are each arranged on one of a rear surface and an outer surface of an interior space of one of the protrusions.

4. The force measurement device for the fluid control valve according to claim 1, wherein the sensor seat comprises a polygonal structure, and the plurality of stress detection units are arranged on one of a side surface and an outer circumferential surface of the polygonal structure to be arranged in an annular configuration and spaced from each other by an angle.

5. The force measurement device for the fluid control valve according to claim 1, wherein the sensor seat has an annular structure and the plurality of stress detection units are arranged, in an annular configuration, and positioned on an outer circumferential surface of the annular structure and are spaced from each other by an angle.

6. The force measurement device for the fluid control valve according to claim 1, wherein the control device comprises:
a processor unit, which is connected to the plurality of stress detection units, the processing unit being operable to determine data of the force applied to the valve rod of the fluid control valve according to the plurality of stress variation signals detected by the plurality of stress detection units;
a transmission module, which is connected to the processor unit, the data of the force being transmittable through the transmission module; and
an electrical power supply unit, which supplies electrical power to the processor unit and the transmission module.

7. The force measurement device for the fluid control valve according to claim 6, wherein the control device optionally comprises a pressure sensor unit and a flow sensor unit that are connected to the processing unit to respectively sense a pressure and a flow rate of fluid passing through the fluid control valve.

8. The force measurement device for the fluid control valve according to claim 6, wherein the transmission module is one of a wireless transmission module and a wired transmission module.

9. The force measurement device for the fluid control valve according to claim 8, wherein the wireless transmission module comprises a wireless transmitter the receiver is one of a smart phone, a personal wearable device, a gateway, cloud or a wireless network.
